(19) United States
(12) Patent Application Publication
(10) Pub. No.: US 2001/0028498 A1
(43) Pub. Date: Oct. 11, 2001

(54) Binocular telescope with imaging function

(75) Inventors: Shunichi Haga, Tokyo (JP); Toshio Sosa, Narashino-Shi (JP)

Correspondence Address: MORGAN, LEWIS & BOCKIUS, 1800 M STREET NW, WASHINGTON, DC, 20036-5869, US

(73) Assignee: Nikon Corporation

(21) Appl. No.: 09/818,633

(22) Filed: Mar. 28, 2001

(30) Foreign Application Priority Data
Mar. 31, 2000 (JP) 2000-099209

(51) Int. Cl. G02B 21/36

(52) U.S. Cl. 359/407; 359/363; 359/410; 359/411

(57) ABSTRACT

A binocular telescope with an imaging function, comprises binocular optical systems including a couple of observation optical systems having objective lenses and eyepieces, and an imaging device including an imaging optical system, for actualizing a visual field of a field angle that is substantially equal to a real field of an image observed through the binocular optical systems, and a photoelectric converting unit for converting an image obtained by the imaging optical system into an electric signal. The observation optical system and the imaging optical system have their optical axes different from each other.

This application claims the benefit of Japanese Applications No.2000-099209 which is hereby incorporated by reference.

### BACKGROUND OF THE INVENTION

1. Field of the Invention

The present invention relates generally to a binocular telescope, and more particularly to a binocular telescope with an imaging function.

2. Related Background Art

A binocular telescope is normally used for an observer to observe an object with the naked eyes. A binocular telescope capable of recording an observed image has been proposed recently. For example, Japanese Patent Publication No.2624556 discloses a binocular telescope with a recording/reproducing device. This binocular telescope takes such a structure that a half-mirror is interposed in a light path to diverge the light path, and the light entering the binocular telescope is guided to an imaging system to form an image.

If the light path is diverged by the half-mirror etc towards binocular optical systems and an imaging optical system, a quantity of the light to the binocular optical systems decreases. Therefore, a problem is that an image of the binocular image is darkened. Further, supposing that the half-mirror is provided on one of the light paths of the binocular optical systems, a difference in the light quantity between the right and left sides occurs, resulting in a problem that the eyes of the observer might be fatigued. In this case, if attempting to eliminate the difference in the light quantity between the right and left sides, there is no alternative but to insert an ND filter on the brighter side to adapt to the light quantity on the darker side. Hence, eventually it inevitably darkens on the whole.

Further, it can be considered that a switching structure is applied to the half-mirror for diverging the light path. There must be, however, a necessity of preparing a mechanism for moving the half-mirror, a space for accommodating the half-mirror moved off and a casing for covering the same mechanism and the space. This results in a problem that the mechanism becomes complicated.

On the other hand, a display device, e.g., a liquid crystal display device of an electronic camera that has spread over the recent years, is used as a viewfinder. Namely, this is a method of getting an image from the binocular telescope displayed on the display device of the electronic camera, and observing this displayed image. This method is effective in an observation for a comparatively short period of time as in the case of typical photographing by use of the camera. Depending on the applications of the binocular telescope, however, the observation may often last for a long period of time as in the case of watching birds, watching sport games, etc. Hence, there arises a problem that a consumption of the electricity increases. Another problem is that the image is hard to observe in terms of considering a relationship between the observer and a visual field and an influence of external light because of providing no ocular optical systems unlike the binocular telescope.

### SUMMARY OF THE INVENTION

It is a primary object of the present invention to provide a binocular telescope with an imaging function that is capable of making an observation by the binocular telescope and executing an imaging process by an imaging device, independently.

To accomplish the above object, according to one aspect of the present invention, a binocular telescope with an imaging function comprises binocular optical systems including a couple of observation optical systems having objective lenses and eyepieces, and an imaging device including an imaging optical system, for actualizing a visual field of a field angle that is substantially equal to a real field of an image observed through the binocular optical systems, and a photoelectric converting unit for converting an image obtained by the imaging optical system into an electric signal, wherein the observation optical system and the imaging optical system have their optical axes different from each other.

The binocular telescope with the imaging function according to the present invention has the binocular optical systems including the couple of observation optical systems for observing an object, and the imaging device for imaging an image obtained by the imaging optical system different from the observation optical systems.

### BRIEF DESCRIPTION OF THE DRAWINGS

FIG. 1 is a top view showing an external configuration of a binocular telescope in a first embodiment of the present invention;

FIG. 2 is a front view thereof;

FIG. 3 is an explanatory view showing an outline of binocular optical systems and a display/operation device in the first embodiment;

FIG. 4 is a block diagram showing one example of an imaging device that can be used in the binocular telescope according to the present invention;

FIG. 5 is a partial fragmentary top view showing hinge members for connecting lens barrel units to an intermediate unit, a battery accommodated therein, and an interpupillary distance adjusting mechanism;

FIG. 6 is an explanatory view showing the interpupillary distance adjusting mechanism;

FIG. 7 is a top view showing an external configuration of the binocular telescope in a second embodiment of the present invention;

FIG. 8 is a side view showing another example of the second embodiment;

FIGS. 9A, 9B and 9C are explanatory views showing how a rotation visual field frame position is adjusted;

FIG. 10 is a top view showing an external configuration of a main unit 1 of the binocular telescope in a third embodiment of the present invention;

FIG. 11 is a front view showing a binocular telescope main unit on the object side in FIG. 10;

FIG. 12 is an explanatory view showing a geometry of optical systems of the binocular telescope and a sub unit 10 in the third embodiment of the present invention;

FIG. 13 is a block diagram showing a construction of a signal processing circuit of the binocular telescope in the third embodiment of the present invention;

FIG. 14 is a block diagram showing a construction of a circuit for auto-focusing control among the signal processing circuits of the binocular telescope in the third embodiment of the present invention; and

FIG. 15 is a graph showing a relationship between an amplitude of a high frequency component of a video signal used for the auto-focusing control of the binocular telescope and a position of a movable lens holder 54 in the third embodiment of the present invention.

### DETAILED DESCRIPTION OF THE PREFERRED EMBODIMENTS

A binocular telescope according to the present invention includes a binocular optical system having a couple of observation optical systems for observing an object, and an imaging device for taking (imaging) an image obtained by an imaging optical system different from the observation optical system.

Embodiments of the present invention will hereinafter be described with reference to the accompanying drawings.

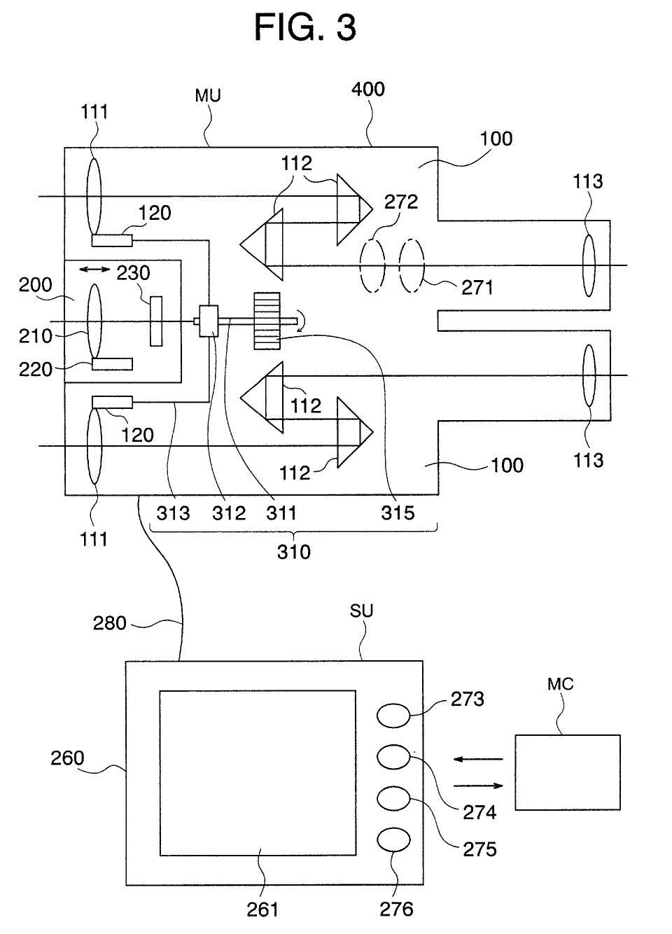

The binocular telescope in one embodiment of the present invention includes, as shown in FIG. 3, a binocular telescope main unit MU and a sub unit SU provided separately from this main unit MU but connected to the main unit MU via a cable 280.

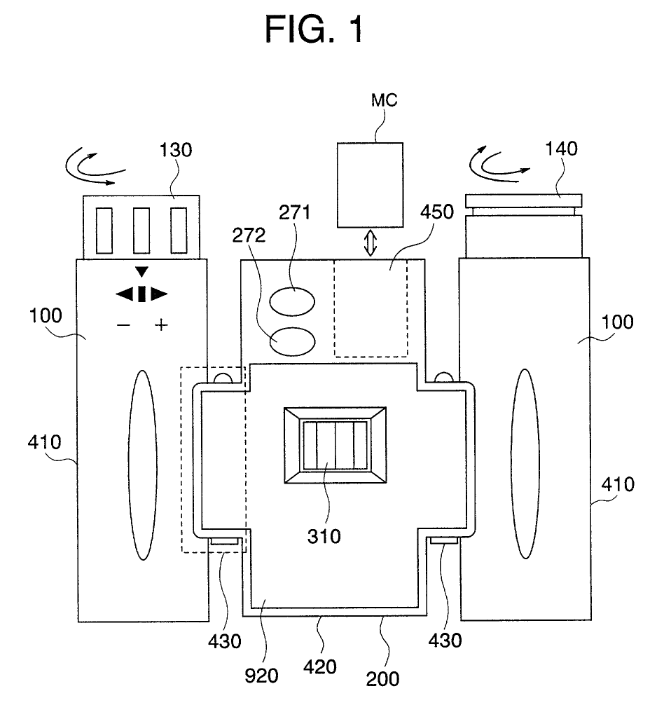

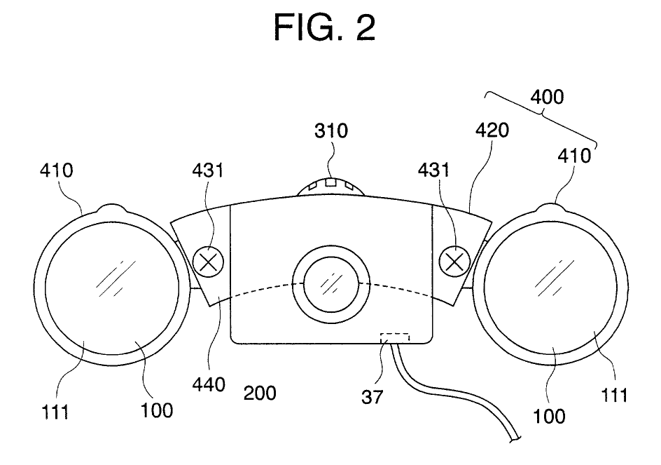

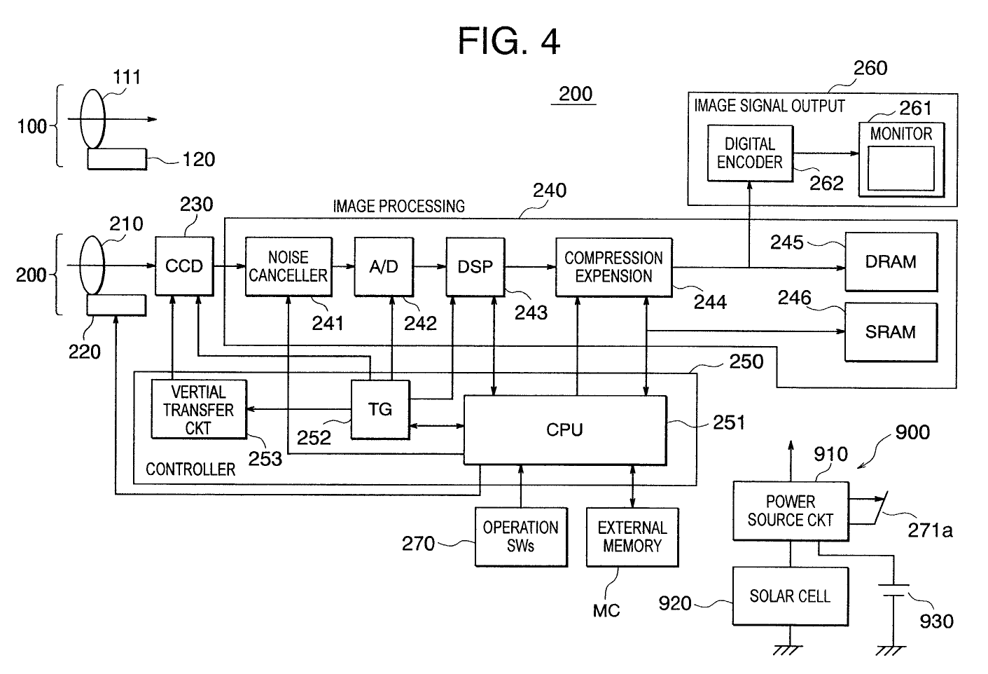

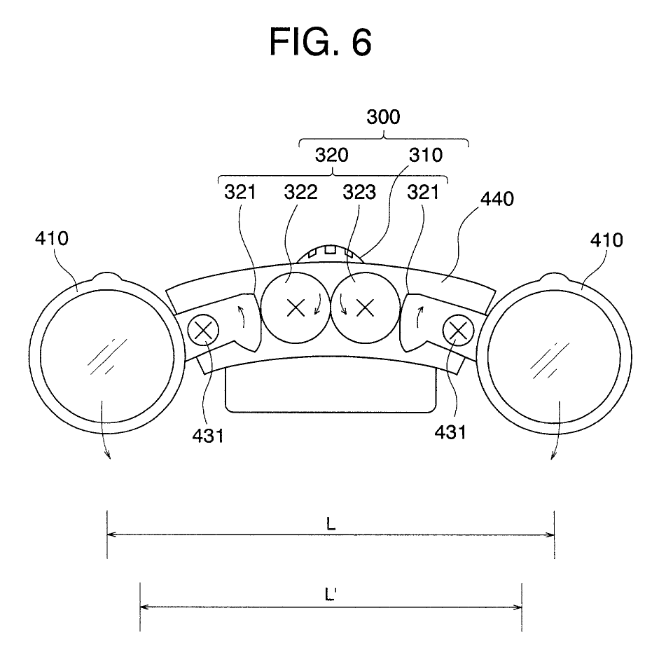

The binocular telescope main unit MU incorporates, as shown in FIGS. 1 and 2, binocular optical systems 100, an operation mechanism 300 (see FIG. 6) for executing an operation for the binocular optical systems 100, and a casing 400 that encases these components. In this embodiment, the casing 400 further encases an imaging device 200 and a power supply device 900 (see FIG. 4).

The casing 400, as shown in FIGS. 1, 2, 5 and 6, has a couple of lens barrel units 410 for accommodating the binocular optical systems 100, an intermediate unit 420 that accommodates the operation mechanism 300 and the imaging device 200, hinge members 430 for rotatably connecting each of the lens barrel units 410 to the intermediate unit 420, and a fixing member 440 for connecting the couple of hinge members 430.

Further, in this embodiment, a card slot 450 for inserting a memory card MC defined as a recording medium as well as being used an external memory, is provided in the rear of the intermediate unit 420. Note that the card slot may be, as will be explained later on, provided also in the sub unit SU. Accordingly, if provided in the sub unit SU, the card slot 450 may be omitted.

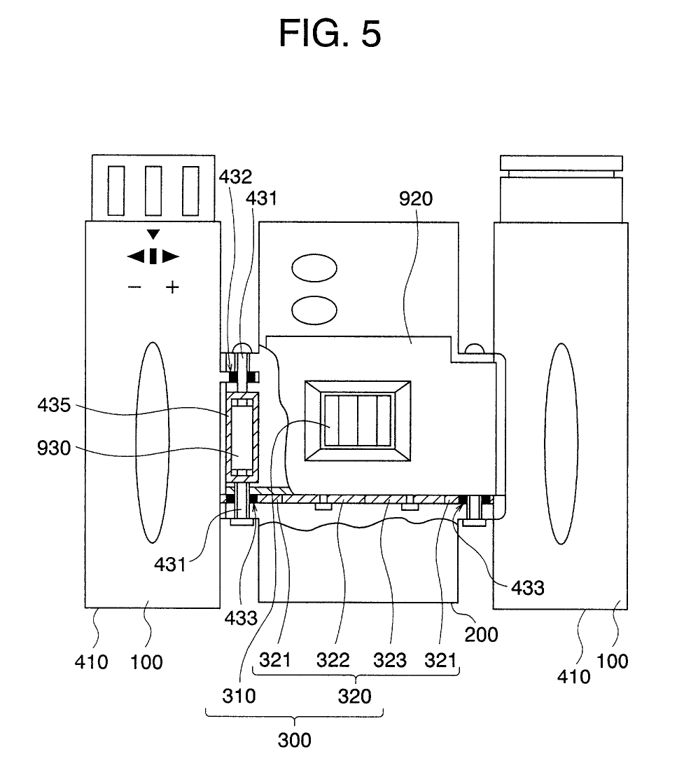

As shown in FIG. 5, the hinge member 431 has a rotary shaft 431 and bearings 432 for bearing the rotary shaft 431. Further, in this embodiment, for example, as shown in FIG. 5, the hinge member 431 is provided with battery storage chambers 435. The couple of battery storage chambers 435 are provided on right and left sides. This arrangement enables a space of the hinge members 430 to be used effectively. The battery storage chamber 435 accommodates a battery 930.

The binocular optical systems 100 are constructed of a couple of observation optical systems provided on the right and left sides. As FIG. 3 shows an outline, each observation optical system includes an objective lens 111, a porro-prism 112 and an eyepiece 113. These elements are accommodated in the lens barrel unit 410 described above. As shown in FIG. 1, one binocular optical system 100 is provided with a visual field frame adjusting unit 140 at the side end of the eyepiece 410 (in the rear of the eyepiece) of the lens barrel unit 410, while the other binocular optical system 100 is provided with a diopter adjusting unit 130.

Further, as shown in FIG. 3, a support member 120 for supporting the objective lens 111 is connected to each observation optical system of the binocular optical system 100. The support member 120 is connected to a focusing operation mechanism 310. The focusing operation mechanism 310 includes a rotary shaft 311, a feed member 312, a connecting member 313, and a focus knob 315. The rotary shaft 311 has a screw provided at the front side end thereof, and rotates with a rotation f the focus knob 315. The feed member 312 meshing with a thread of the rotary shaft 311 and thus moves with rotations of the rotary shaft 311. The connecting member 313 connects the feed member 312 to the support member 120, and transmits the movement of the feed member to the support member 120. Accordingly, when the user rotates the focus knob 315 to move the objective lens 111 along an optical axis, thereby focusing.

Note that the focusing through the objective lens 111 in the binocular optical system 100 is not limited to the manual mode described above. For instance, an unillustrated actuator may be driven by use of an auto-focus adjust signal (AF signal) generated based on an image signal used for a known video camera etc, whereby the objective lens 111 may be moved. In accordance with this embodiment, the auto-focus adjust control in the binocular optical system can be attained by use of the AF signal generated in the imaging device 200 that will be explained later on.

The imaging device 200 is disposed in the middle between the binocular optical systems 100. This imaging device 200 includes, as shown in FIGS. 3 and 4, an imaging optical system 210, a lens drive unit 220 for moving the objective lens as a component of the imaging optical system 210, a photoelectric converting unit 230 for converting an observation image formed by the imaging optical system 210 into an electric signal, an image processing unit 240 for processing the thus converted image signal, and a control unit 250 for controlling operations of these components.

The image processing unit 240 executes a filtering process, signal digitizing process etc with respect to the signals converted by the photoelectric converting unit 230. With these processes, the generated image signal is recorded on or regenerated from the external memory, e.g., a flash memory. Further, it is also feasible to reduce noises and adjust a white balance etc.

The control unit 250 functions as a lens drive control circuit for controlling the lens drive unit 220. The control unit 250 also has a function as an image recording unit for recording the image signal on a recording medium.

Further, as shown in FIG. 4, an image signal output unit 260 for outputting the image signal and a variety of operation switches 270, are connected to the imaging device 200. For example, a liquid crystal monitor may be exemplified as the image signal output unit 260. In this embodiment, the image signal output unit 260 is accommodated in the sub unit SU and connected via a cable 280 to the imaging device 200. This architecture makes it possible to downsize the binocular telescope main unit MU. As a matter of course, the image signal output unit 260 may be, as will be explained later on, provided integrally with the binocular telescope main unit MU. The operation switches 270 are connected to the control unit 250, and operations done upon these switches are inputted to the control unit 250. Some of the operation switches 270 are, as illustrated in FIG. 1, provided in the binocular telescope main unit MU. Further, the rest of those switches 270 are provided in the sub unit SU as shown in FIG. 3.

The imaging optical system 210 is disposed in a position in between the couple of binocular optical systems 100. This imaging optical system 210 is constructed of a lens system having a field angle for actualizing a field substantially equal to a real field by the binocular optical systems. Namely, the imaging optical system 210 is constructed so that an image substantially approximate to the image formed by the binocular optical systems 100 can be formed and recorded (which implies that (Angle of Imaging Optical System 100)=(Real Field Angle of Binocular Optical System)). Further, a method by which the imaging device 200 obtains the filed of angle that substantially equal to the real field observed through the binocular optical systems 100 may be, in addition to the method of adjusting through the lens system as described above, such that the field angle can be adjusted by thinning out the pixels and executing interpolation with respect to the image converted by a CCD of the photoelectric converting unit 230 and recorded by the image recording unit. Thus, in the case of adjusting the field angle by processing the image, a thin-out rate and an interpolation rate with respect to a lens magnification or the field angle are predetermined, and electrically processed results are outputted.

Note that when taking a zoom method other than obtaining the image approximate to the binocular telescope image, a structure for imaging at an arbitrary magnification may be adopted. In this case, there must be provided a mode for setting in a position of the approximate image.

Moreover, the imaging optical system 210 is provided with the lens drive unit 220 for performing the auto-focusing. This lens drive unit (circuit) 220 is as will be described later on, driven by the AF signal obtained by the control unit 250 executing a focused point detection process. The AF-signal-based driving operation can be carried out in the same way as the auto-focusing performed by moving the objective lens of the imaging system through the AF signal generated from the image signal used for the video camera etc.

The photoelectric converting unit 230 converts the observed image formed by the imaging optical system 210 into the electric signal, and is constructed of, e.g., a CCD. The image signal converted into the electric signal is transmitted to the image processing unit 240. Note that the photoelectric converting unit 230 includes an unillustrated CCD drive circuit.

The image processing unit 240 includes, as shown in FIG. 4, a noise canceler 241 for filtering the noses contained in the electric signals outputted from the photoelectric converting unit 230, and an analog/digital converter (A/D converter) 242 for converting an analog image signal into a digital image signal. The image processing unit 240 further includes a digital signal processor (DSP) 243 for executing a variety of correcting processes with respect to the digital image signals, a compression/expansion circuit 244 for compressing and expanding the signal, a dynamic random access memory (DRAM) 245 for recording the digital image signal being compressed, and a static random access memory (SRAM) 246.

The noise canceler 241 has a correlated double sampling (CDS) function for reducing the noise components of the photoelectrically converted electric signals (image signals) of the image formed on the imaging device (CCD) 6 through the imaging lens 5, and an AGC (Automatic Gain Control) function of automatically controlling a gain. A decrease in noises and a gain adjustment are attained by this noise canceler 241.

The DSP (Digital Signal Processor) 243 executes a data interpolation process, a gamma correction, a knee correction, a matrix correction and an outline correction with respect to the digital image signals. Thereafter, the DSP 243 generates data of a luminance signal and a color difference component, and inputs the digital image signal after being corrected to the compression/expansion circuit 23.

The compression/expansion circuit 23 incorporates a DCT (Discrete Cosine Transform)/reverse-DCT operation module and a Huffman code/composite logic module, and compresses and expands the data based on the JPEG (Joint Photographic Experts Group) system. The compression/expansion circuit 23 has a function of writing the data to the DRAM 26 and executing a data access to the DRAM 26, and also has a refresh function.

The SRAM 27 is classified as a buffer memory for temporarily storing the image data before finally storing the flash memory (PC card) 16 with the data in the form of recorded image signals after being compressed in a way of giving header information as a JPEG file.

The control unit 250 has a CPU 251, a timing generator (TG) 252 and a vertical transfer drive circuit 253.

The CPU 251 executes a variety of control operations in accordance with a program recorded in a built-in program memory. The CPU 251 controls, for instance, the function as the lens drive control circuit, the operation of the photoelectric converting unit 230, the operation of the image processing unit 240, the output of the image signal, the process of writing the image signal to the recording medium, and an accept of the inputs from the operation switches 270.

The timing generator 252 may be defined as a circuit for generating a clock signal for supplying the photoelectric converting unit (CCD) 241 with a vertical transfer pulse via the vertical transfer drive circuit 253, and with a variety of timing signals of the whole circuits.

The image signal output unit 260 includes, as shown in FIG. 4, for example, a liquid crystal monitor (LCD monitor) 261, and a digital encoder 262 for modulating the digital data into analog video signals for display. In accordance with this embodiment, the image signal output unit 260 is, as shown in FIG. 3, accommodated in to sub unit SU. The LCD monitor 261 displays the analog video signals modulated. Further, the LCD monitor 261 functions as an electronic viewfinder for making a confirmation etc before imaging. Note that the liquid crystal monitor 261 may also displayed directly by use of the digital data.

The sub unit SU is provided with, in addition to what has been given above, operation switches 273 to 276 and a card slot (not shown) for the memory card MC.

The operation switches 270 include the operation switches 271, 272 provided in the rear part of the intermediate portion of the binocular telescope main unit MU, and the operation switches 273 to 276 provided in the sub unit SU described above. The operation switch 271 is a power source switch, and the operation switch 272 is a record switch for indicating the record of the image. Further, the operation switches 273, 274, 275 and 276 are classified in this sequence as a reproduction switch, a forward switch, a backward switch and an erase switch.

The power source device 900 includes a power source circuit 910, a battery 930 and a solar cell 920. The solar cell 920 is used as a part of the power source and disposed on the side of an upper surface of the intermediate unit 420. On the other hand, the battery 930 is stored in the battery storage chamber 435 provided in the hinge member 430. The power source circuit 910 generates a predetermined voltage, and controls charging the battery 930 with electric charges given from the solar cell.

The operation mechanism 300 has, in addition to the focusing operation mechanism 310, an interpupillary distance adjusting mechanism 320.

The interpupillary distance adjusting mechanism 320 is, as illustrated in FIGS. 5 and 6, disposed along a fixing member 440 for connecting at the hinge members 431 the right and left observation optical systems of the binocular optical systems 100. Namely, the interpupillary distance adjusting mechanism 320 is structured that the bearing 433 are respectively provided with the gears 321, between which gears 321 an even-number, two pieces in the case of FIGS. 5 and 6, of connection gears 322, 323 are disposed. The reason why the even-number of connection gears are provided is that the right and left rotations act in the same direction.

Next, a mechanism for preventing a tilt of the image formed by the binocular optical systems 100 when adjusting the interpupillary distance, will be explained.

In a general type of binocular telescope, the interpupillary distance is adjusted by moving he right and left binocular optical systems 100 so as to rotate them about one axis or two axes. If the imaging optical system 210 is provided in the binocular telescope main unit MU, there arises a problem in which the image formed rotates and inclines with respect to the binocular optical image observed due to the adjustment of the interpupillary distance.

The interpupillary distance adjusting mechanism as shown in FIGS. 5 and 6 is provided, however, the problem given above can be obviated.

As shown in FIG. 6, if an interpupillary distance L is set to L′, when one of the lens barrel units 410 is rotated in an arrow direction, the other lens barrel unit 410 rotationally moves interlocking with the same quantity. In this case, the binocular telescope main unit is set horizontal so that the binocular image observed becomes horizontal. Through not illustrated in FIG. 6, an image of the imaging optical system 210 thereby becomes horizontal, and hence the problems described above is obviated.

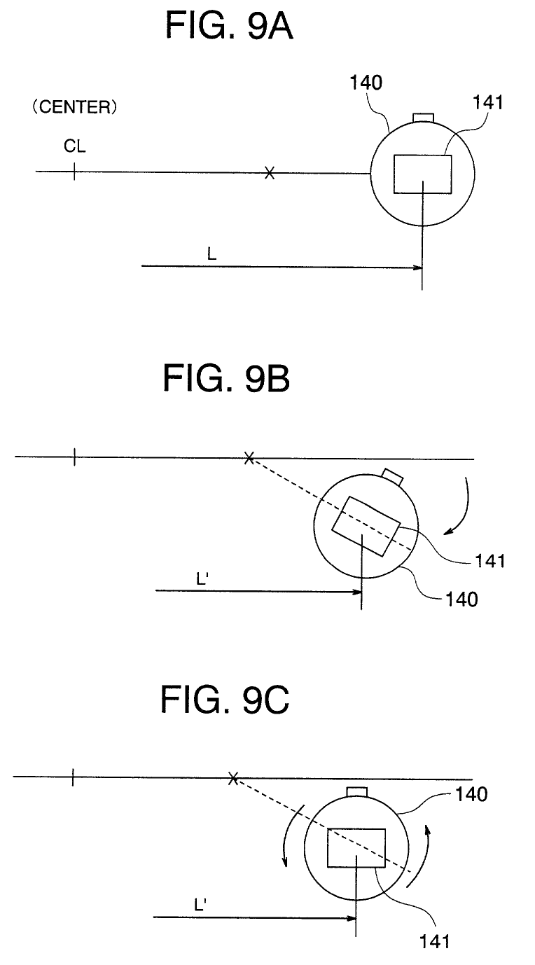

Referring next to FIG. 9A, the visual field frame 141 for defining the imaging range is provided together with a visual field frame rotary unit 140. The visual field frame rotary unit 140 is so disposed as to be rotatable with a frictional load given to a front side end of an eye cushion rubber. This visual field frame 141, as shown in FIG. 9B, rotationally moves when adjusting the interpupillary distance. As illustrated in FIG. 9C, however, the visual field frame 141 can be used in a normal frame position by rotationally returning it to the previous horizontal position after adjusting the interpupillary distance.

Next, an example of how the binocular telescope in this embodiment is used, will be explained.

The user, ahead of the using the binocular telescope, to start with, adjust the interpupillary distance. This adjusting method has already been described, and therefore its repetitive explanation is not given herein. Thereafter, the visual field frame adjustment and a diopter adjustment are made.

Subsequently, an object is observed through the binocular telescope. On this occasion, the user indicates the focusing operation mechanism 310 to execute focusing, or gives an indication to execute the auto-focusing process.

When used as the binocular telescope, an enlarged image formed by transforming the incident light via the right and left objective lenses 111 into an erect image by use of the porro-prism 112, is observed through the eyepieces 113, whereby the present binocular telescope can be used as a normal binocular telescope.

When recording the binocular telescope image, the binocular telescope main unit MU is connected via the connection cable 280 to the sub unit SU, the operation switch (power source SW) 271 is switched ON, and the operation switch (record SW) 272) is pressed. With this operation, the binocular telescope image, of which the light emerges from the imaging lens 5, formed on the imaging device 6, and an approximate object image are recorded in the flash memory (PC card) MC after being subjected to the photoelectric converting process, the A/d converting process and the image compression (based on JPEG etc) process.

Further, as the necessity may arise, the image before the imaging process can be confirmed on the liquid crystal monitor 261 of the sub unit SU.

After being recorded, the recorded image is fed frame by frame and displayed in reproduction or erased on the liquid crystal monitor 261 by operating the operation switches (the reproduction SW 273, the forward SW 274, the backward SW 275 and the erase SW 276) of the sub unit SU.

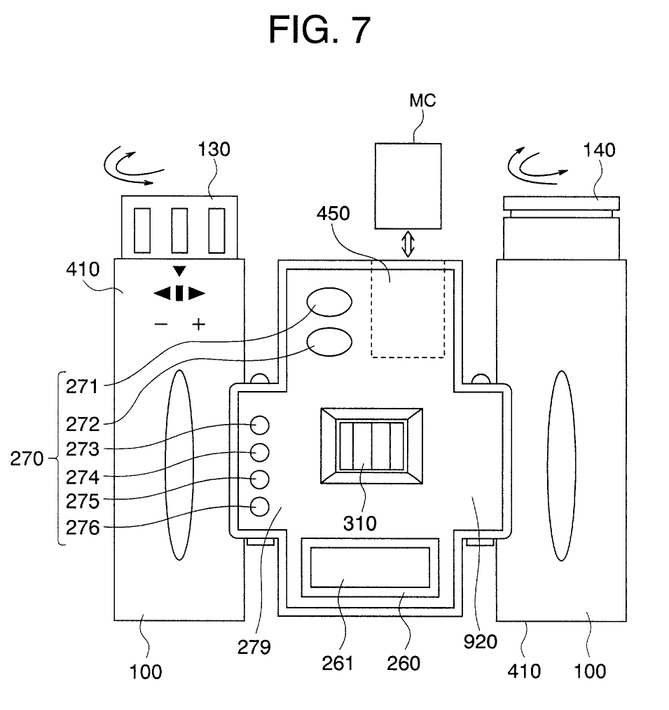

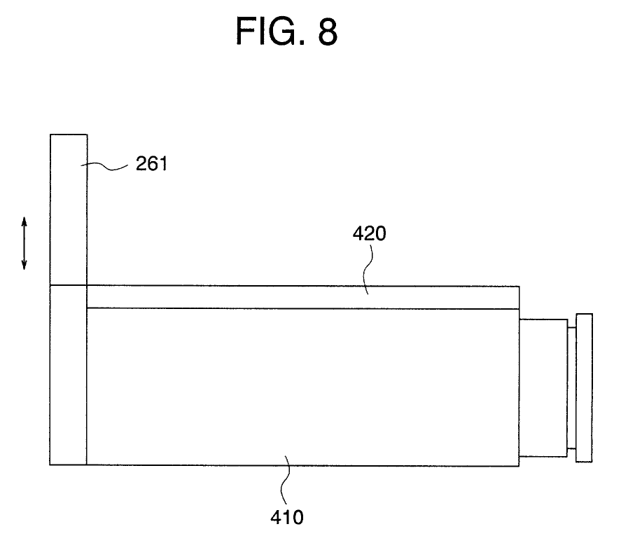

Next, a second embodiment of the present invention will be discussed with reference to FIGS. 7 and 8.

The binocular telescope in the second embodiment has the same basic configuration of the binocular telescope as in the first embodiment illustrated in FIG. 1. The binocular telescope in the second embodiment is different in terms of a point that the image signal output unit 260 is provided in the binocular telescope main unit MU, a point that the solar cell 920 is disposed covering almost all the front surface of the upper portion of the intermediate unit 420, a point that all the operation switches 270 are provided in the binocular telescope main unit MU, and a point that the operation switches 270 are constructed of a touch panel 279 composed of transparent electrodes. Namely, the second embodiment does not use the sub unit SU. The discussion will herein concentrate on the different points.

The liquid crystal monitor 261 of the image signal output unit 260 is disposed on a front-sided upper surface of the intermediate unit 420. Accordingly, a display screen on the liquid crystal monitor 261 can be viewed from above in a state where the binocular telescope is set horizontal.

The liquid crystal monitor 261 is, as shown in FIG. 8, fitted to the intermediate unit 420 so that its display screen can be protruded upwardly of the intermediate unit 420 in a state facing to the observer. The liquid crystal monitor 261 is structured so that when not used, the same monitor 261 is disposed at a front side end of the intermediate unit 420 and protruded upwards when the binocular telescope is used. In this case, the display screen on the liquid crystal monitor is visible at its surface intersecting the upper surface of the intermediate unit in a state of its facing backwards. With this structure, the user is able to see the display screen simply by moving the eyes slightly off the binocular telescope. Accordingly, it hardly happens that the user fails to fix the eyes on the object out of the visual field, which is being observed through the binocular telescope. Further, a user-friendly screen can be actualized. Note that the liquid crystal monitor 261 may also be structured to be protrudable downwardly of the intermediate unit 420.

In the second embodiment, the solar cell 920 is disposed covering almost all the front surface of the upper portion of the intermediate unit 420. With this configuration, the output of the solar cell can be increased. The binocular telescope is used outdoors during the daytime in many cases, it can be said that it is preferable to acquire the electric energy through the solar cell.

Next, the second embodiment does not use the sub unit, and hence all the operation switches 270 are provided in the binocular telescope main unit MU. Accordingly, the various operations can be performed by fingertips while holding the binocular telescope.

Moreover, in the second embodiment, the operation switches 270 are constructed of the touch panel 279 composed of the transparent electrodes. Therefore, the solar cell can work even at the portion where the operation switches 270 exist.

A third embodiment will hereinafter be described with reference to the accompanying drawings.

The binocular telescope in the third embodiment includes a couple of right and left binocular optical systems for observing the object, and an imaging device separate from this binocular telescope. The binocular telescope in the third embodiment actualizes an auto-focusing (AF) mechanism, wherein a focal point is detected from outputs of the binocular optical systems, the binocular optical systems and a movable lens of the imaging device are moved based on a result of this detection, thereby adjusting the focuses of the binocular optical systems and of the imaging device.

A geometry of the binocular telescope in the third embodiment will hereinafter be specifically described.

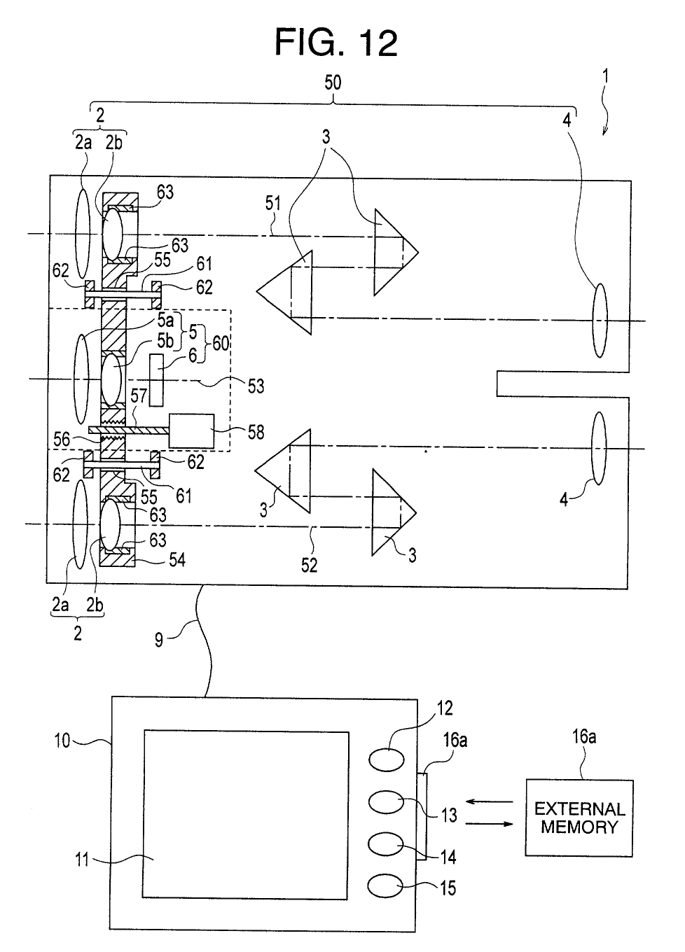

The binocular telescope in the third embodiment has, as shown in FIG. 12, a main unit 1 and a sub unit 10 connected via a cable 9 to the main unit 1. The main unit 1 incorporates binocular optical systems 50 constructed of a couple of optical systems disposed on the right and left sides, and an imaging device 60. The binocular optical system 50 includes an objective lens 2, a porro-prism 3 and an eyepiece 4, which are arranged on each of a couple of optical axes 51, 52 for right and left eyes. The objective lens 2 has a fixed lens 2a disposed on the side of an observing object, and a movable lens 2b disposed on an ocular side. The movable lenses 2b are moved along the optical axes 51, 52, thereby adjusting the focal points of the binocular optical systems 50. On the other hand, the imaging device 60 has an imaging lens 5 and a CCD 6 on an optical axis 53 positioned between the optical axes 51 and 52. The imaging lens 5 includes an imaging fixed lens 5a disposed on the side of the observing object, and an imaging movable lens 5b disposed on the side of the CCD 6. The imaging movable lens 5b is moved along the optical axis 53, thereby adjusting a focal point of the imaging device 60.

Note that a field angle of the imaging device 60 is designed to attain a visual field substantially equal to the real field of the binocular optical system 50. For attaining this, the field angle is adjusted when making an optical design of the imaging lens 5. Other than this method, the field angle can be adjusted by an image process for processing an image taken by the CCD 6.

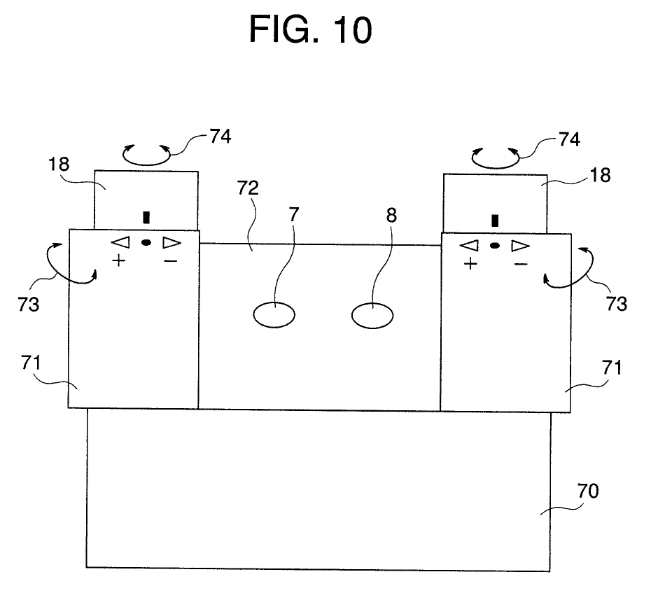

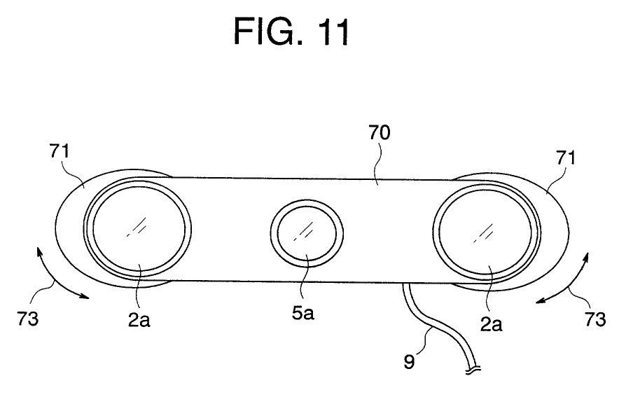

Further, the binocular telescope main unit 1 includes, as shown in FIGS. 10 and 11, an object-sided lens barrel 70, right and left ocular-sided lens barrels 71, and a box 72 disposed between the right and left ocular-sided leans barrels 71. Diopter adjusting rings 18 are fitted to the right and left ocular-sided leans barrels 71. The object-sided lens barrel 70 incorporates, as shown in FIG. 12, the right and left objective lenses 2 of the binocular optical systems 50 and the imaging device 60. Further, the porro-prisms 3 are incorporated into the right and left ocular-sided lens barrels 71. The eyepieces 4 are set in the diopter adjusting rings 18. Note that the right and left ocular-sided lens barrels 71 are so constructed as to rotate in an arrow direction 73 in FIGS. 10 and 11 with respect to the object-sided lens barrel 70. Thus, a spacing between the right and left eyepieces 4 can be narrowed by rotating the ocular-sided lens barrels 71, whereby the interpupillary distance can be adjusted. Note that the porro-prisms 3 are constructed to form an erect image with no rotation of an ocular image in the case of rotating the ocular-sided leans barrels 71.

Further, the diopter adjusting ring 18 includes an eye cushion rubber. The diopter adjusting rings 18 are structured to rotate in an arrow direction 74 in FIG. 10 with respect to the object-sided lens barrel 70. With these rotations, the eyepieces 4 move by a quantity corresponding to a quantity of rotations along the optical axes 51, 52. Hence, the diopter can be adjusted by rotating the diopter adjusting rings 18. Moreover, the box 72 is provided with operation switches such as a power source switch 7 and a record switch 8 on its upper surface, and encases signal processing circuits for the auto-focusing, the image process etc. These signal processing circuits will hereinafter be explained in depth.

Further, as shown in FIG. 12, a movable lens holder 54 holds both of the couple of right and left movable lenses 2b of the binocular optical systems 50 and the imaging movable lens 5b of he imaging device 60. Th movable lens holder 54 is structured to hold these three pieces of lenses simultaneously. The movable lens holder 54 is formed with two guide holes 55 extending in parallel with the optical axes 51, 52, 53 in their axial direction. Shafts 61 are slidably fitted into the two guide holes 55. Both side ends of the shaft 61 are fixed to the lens barrel 70 with fixing members 62 serving as stoppers. Further, the movable lens holder 54 is formed with screw hole 56 whose axial direction is formed in parallel with the optical axes 51, 52, 53. Ball screw 57 is inserted into and thus mesh with the screw hole 56. A stepping motor 58 for rotating the ball screw 57 is connected to a side end of the ball screw 57. The stepping motor 58 is fixed to the lens barrel 70. Hence, when the ball screw 57 is rotated by actuating the stepping motor 58, the screw hole is moved with this rotation, and the movable lens holder 54 moves a distance corresponding to a quantity of this rotation along the shaft 61. The movable lens holder 54 can be thereby moved in the direction of the optical axes 51, 52, 53.

Accordingly, the movable lens holder 54 is moved to a position where the binocular optical system 50 and the imaging device 60 attain focusing at the same time, thereby making it feasible to simultaneously actualize the auto-focusing of the binocular optical systems 50 and the auto-focusing of the imaging device 60. A quantity of movement of the movable lens holder 54 is controlled by an AF control unit etc that will be explained later on.

Note that when the movable lenses 2b and the imaging movable lenses 5b are set in the movable lens holder 54 at a manufacturing stage, set positions of the movable lenses 2b and the imaging movable lenses 5b in the movable lens holder 54 are adjusted beforehand. That is, the movable lenses 2b and the imaging movable lens 5b are set in the positions predetermined in design of the movable lens holder 54, and the movable lens holder 54 is disposed in a focusing reference position in its design. In this state, the imaging device 60 images a reference chart disposed at a reference imaging distance from the binocular telescope, and the CCD 6 is moved and fixed in such a position as to maximize the output of the CCD 6. Next, the position of the movable lens holder 54 remains as it is, and the positions of the movable lenses 2b are minutely adjusted in the movable lens holder 54 till the right and left binocular optical systems 50 attain their focusing. At this time, the diopter adjustments of the binocular optical systems 50 are set in a position “0”. This fine adjustment is made by adjusting a thickness of a spacer 63, in the directions of the optical axes 51, 52, for fixing each of the movable lenses 2b to the movable lens holder 54. With this adjustment, the movable lens holder 54's position for setting the imaging device 60 in the in-focus state becomes coincident with the movable lens holder 54's position for setting the binocular optical systems 50 in the in-focus state. Accordingly, the movable lens holder 54 is moved to the position where the imaging device 60 comes to its in-focus state, whereby the binocular optical systems 50 simultaneously attain the auto-focusing.

On the other hand, the sub unit 10 is provided with the liquid crystal monitor 11, the reproduction switch 12, the forward switch 13, the backward switch 14 and the erase switch 15 on its external surface. These switches 12˜15 are used for reproducing and erasing the images stored in the memory. Further, a side surface of the sub unit 10 is formed with a slot 16a for mounting an external memory 16 such as a flash memory etc for storing the image taken by the imaging device 60. The sub unit 10 incorporates a digital encoder 262 for modulating the digital data into the analog video signal for displaying the image on the liquid crystal monitor 11.

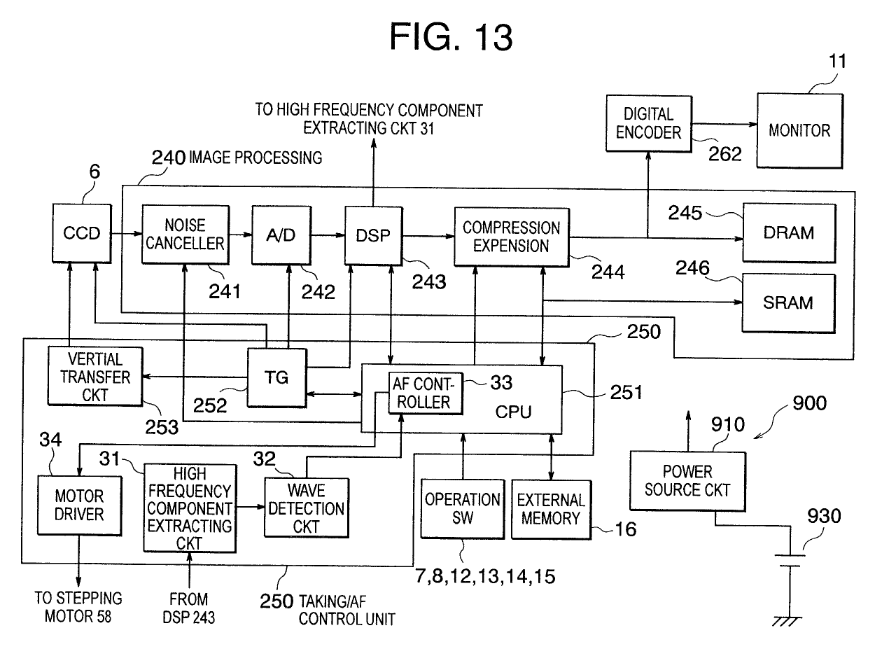

Next, the signal processing circuits provided in the box 72 of the binocular telescope main unit 1, will be explained referring to FIG. 13. Each of these signal processing circuits includes an image processing unit 240, and an imaging/AF control unit 250 for executing the imaging control and the AF control. Further, the box 72 encases these signal processing circuits and also a power source unit 900 for supplying the electric power to the CCD 6 and the stepping motor 58.

The image processing unit 240 includes, as shown in FIG. 13, the noise canceler 241 for filtering the noses contained in the electric signals outputted from the CCD 6, and the analog/digital converter (A/D converter) 242 for converting the analog image signal into the digital image signal. The image processing unit 240 further includes the digital signal processor (DSP) 243 for executing the variety of correcting processes with respect to the digital image signals, a compression/expansion circuit 244 for compressing and expanding the signal, a dynamic random access memory (DRAM) 245 for recording the digital image signal before being compressed, and a static random access memory (SRAM) 246.

The noise canceler 241 has the correlated double sampling (CDS) function for reducing the noise components of the electric signals (image signals) photoelectrically converted by the CCD 6, and the AGC (Automatic Gain Control) function of automatically controlling the gain. This noise canceler 241 decreases the noises and controls the gain. The A/D converter 242 converts the output of the noise canceler 241 into the digital video signal. The DSP 243 is a circuit for executing the data interpolation process, the gamma correction, the knee correction, the matrix correction and the outline correction with respect to the digital image signals given from the A/D converter, and thereafter generating the data of the luminance signal and the color difference component.

The compression/expansion circuit 244 incorporates the DCT (Discrete Cosine Transform)/reverse-DCT operation module and the Huffman code/composite logic module, and executes the compression/expansion process based on the JPEG (Joint Photographic Experts Group) system. The compression/expansion circuit 244 has the function of writing the data to the DRAM 245 and executing a data access to the DRM 26, and also has the refresh function. The compression/expansion circuit 244 stores the DRAM 245 with the digital video signals before being compressed. The SRAM 246 is classified as the buffer memory for temporarily storing the digital video signal given the header information as a JPEG file by way of the video signal for recording. This record video signal is eventually stored in the external memory 16 via the CPU 251. Further, the output of the compression/expansion circuit 244 is transferred also to the digital encoder 262 of the sub unit 10. The digital encoder 262 is, as already explained, the circuit for modulating the digital data into the analog video signal for displaying. The analog-modulated video signal is displayed on the liquid crystal monitor 261.

On the other hand, the imaging/AF control unit 250 includes a CPU 251, a high frequency component extraction circuit 31, a wave detection circuit 2, a motor driver 34, a timing generator (TG) 252, and a vertical transfer drive circuit 253. The CPU 251 includes an AF control unit 33 for controlling the auto-focusing (AF) of the binocular optical systems and of the imaging device 60.

The CPU 251 operates based on the program recorded on the built-in program memory, thereby actualizing respective functions such as the auto-focusing control of the AF control unit 33, the operation control of the CCD 6, the operation control of the image processing unit 240, the output control of the image signal, and the write control of the image signal to the recording medium. The CPU 251 also receives the inputs from the operation switches 7, 8, 12 to 15.

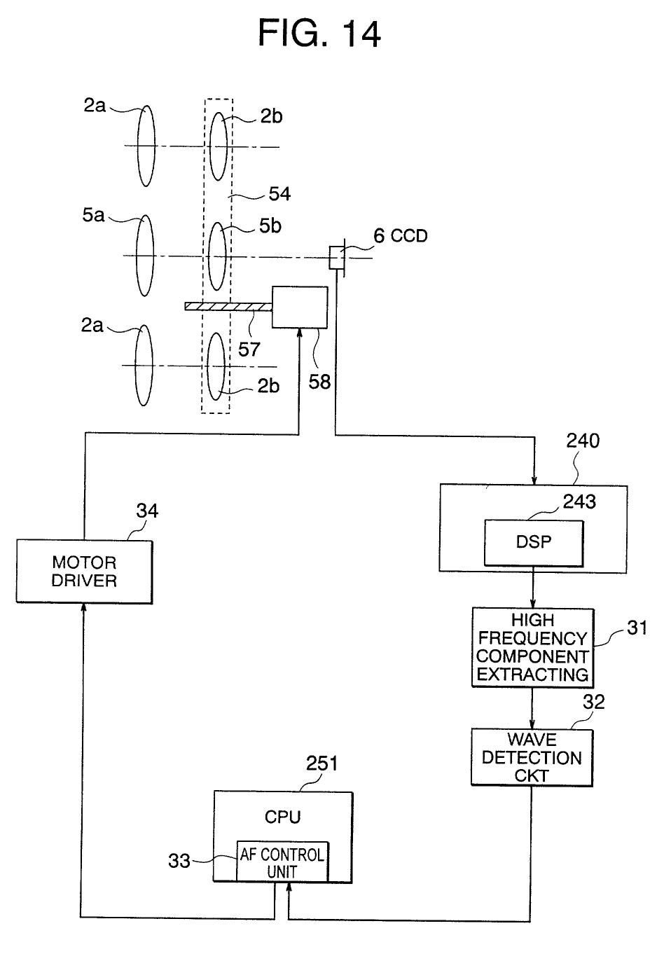

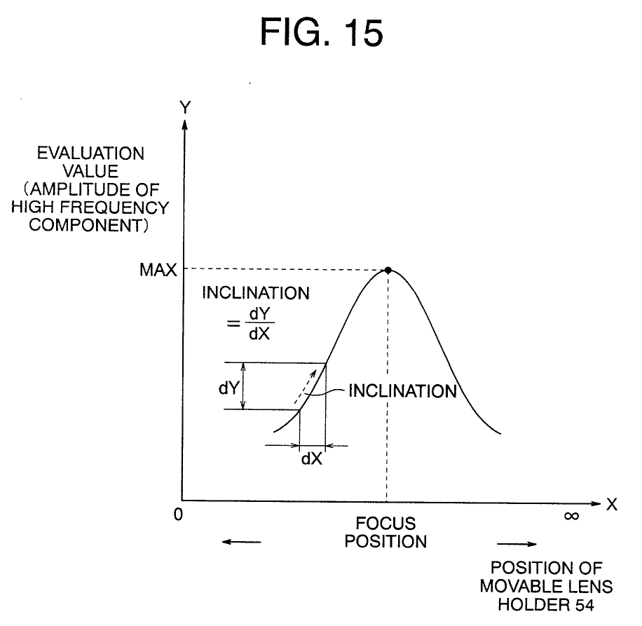

A control circuit for the auto-focusing is configured by the AF control circuit 33, the high frequency component extraction circuit 31, the wave detection circuit 32 and the motor driver 34. These circuits serve to perform the auto-focusing of the binocular optical systems 50 and of the imaging device 60 by controlling the operation of the stepping motor 58 as shown in FIG. 14, and are controlled as a whole by the CPU 251. In accordance with the second embodiment, an amplitude of the high frequency component of the video signal outputted by the CCD 6 comes to its maximum in the in-focus state as shown in FIG. 15, and decreases when deviating from the in-focus state on both sides, and the auto-focusing is carried out by making use of this characteristic. This auto-focusing method is often used for an auto-focus mechanism of a typical video camera etc.

To be specific, the high frequency component extraction circuit 31 receives an output signal of the DSP 243, and extracts a high frequency component of the luminance signal out of the output signal. The wave detection circuit 32 executes a rectification wave detection with respect to the output of the high frequency component extraction circuit 31, thereby obtaining an evaluation value necessary for the auto-focusing (AF). The AF control unit 33 takes in this evaluation value, and calculates a movement quantity with which to move the movable lens holder 54 to a position where the evaluation value is maximized. Then, the AF control unit 33 generates a control signal from a result of this calculation, and outputs the control signal to the motor driver 34. The motor driver 34 drives the stepping motor 58 corresponding to the control signal from the AF control unit 33. At this time, the AF control unit 33 conducts so-called [climb control] under which the movement quantity is calculated so that the evaluation value takes its maximum value and the movable lens holder 54 is thus moved. Further, there is used a method by which the movable lens holder 54 is minutely oscillated in order to examine a direction of the in-focus position from the position of the movable lens holder 54 at the present, and the direction of the in-focus position is presumed and determined based on a positive or negative value given by dy/dx (where y is the evaluation value, x is the position of the movable lens holder 54) of the evaluation value obtained at that time. It is possible to execute the control of getting the imaging device 60 focalized based on the output of the CCD 6 by using this method. With this focalization, the movable lenses 2b of the binocular optical system 50 incorporated into the movable lens holder 54 also moves the in-focus positions, thereby making it feasible to focalize the binocular optical systems 50.

Moreover, the timing generator (TG) 252 of the imaging/AF control unit 250 is a circuit for generating a clock signal and a variety of timing signals of the whole circuits. The vertical transfer circuit 253, based on the clock signal generated by the TG 252, generates a vertical transfer pulse and supplies the CCD 6 with this pulse, thereby controlling the imaging process of the CCD 6.

Further, the power source unit 900 disposed inside the box 72 has the power source circuit 910 and the battery 930. The power source circuit 910 generates a predetermined voltage and supplies this voltage to the respective circuits such as the image processing unit 240 and the imaging/AF control unit 250, the CCD 6 and the stepping motor 58 as well.

Next, a method of using the binocular telescope in the second embodiment and operations of the respective units, will be explained.

The user, before using the binocular telescope, adjusts the interpupillary distance. The interpupillary distance is, as already explained, adjusted by moving the ocular-sided lens barrel 71 in an arrow direction 73 in FIGS. 10 and 11. Further, the diopter is also adjusted by rotating the diopter adjusting rings 18.

Subsequently, the power source switch 7 is pressed to switch ON the power source. With power-ON, the CCD 6 of the imaging device 60 thereby starts imaging, and the output signal is processed by the image processing unit 240 and the imaging/AF control unit 250. Then, the AF control unit 33 controls the position of the movable lens holder 54. Hence, both of the imaging device 60 and the binocular optical systems 50 are controlled in the in-focus states.

Accordingly, the light incident on the fixed lenses 2a of the right and left objective lenses 2 of the binocular optical systems 50 penetrates the movable lenses 2b disposed in the in-focus positions within the movable lens holder 54, thereby forming an enlarged image. This enlarged image is transformed by the porro-prism 112 into an erect image. Hence, the user is able to observe the enlarged image as through the normal binocular telescope by peering it through the eyepieces 113 with both eyes.

Further, the light entering the imaging fixed lenses 5a of the imaging device 60 travels through the imaging movable lenses 5b disposed in the in-focus positions in the movable lens holder 54, thereby forming the enlarged image on the CCD 6. This enlarged image is taken by the CCD 6 and is, after being processed in the respective circuits of the image processing unit 240 as described above, displayed on the liquid crystal monitor 11 of the sub unit 10. The user is therefore able to confirm the thus formed image by seeing the image displayed on the liquid crystal monitor 11.

The contrivance at this time is that the field angle of the imaging device 60 is substantially coincident with the angle of the visual field of the binocular optical system 50, so that the enlarged image which is substantially the same as the enlarged image observed through the binocular optical systems 50, is imaged by the imaging device 60. Hence, the user, when desiring to record the enlarged image observed through the binocular optical systems 50, presses the record switch 8, whereby the CPU 251 stores the external memory 16 with the record video signal subjected to the image processing in the image processing circuit unit 240. It is therefore possible to record the image substantially approximate to the enlarged image observed through the binocular optical systems 50. Note that the record switch 8 is, as shown in FIG. 10, disposed between the two units of eyepiece-sided lens barrels 71 of the binocular telescope main unit, and hence the user is able to press the record switch 8 without getting the eyes off the eyepieces 4. Further, the user is also able to confirm the image before the imaging process on the liquid crystal monitor 11 of the sub unit 10 as the necessity may arise.

The user, if desiring to reproduce the recorded image, presses the reproduction switch 12 of the sub unit 10. With this trigger, the CPU 251 reads the video signal data stored in the external memory 16, and transfers the same data to the digital encoder 262 of the sub unit 10 via the compression/expansion processing circuit 244. The video signal read out of the external memory 16 is thereby displayed on the liquid crystal monitor 11. Further, if the user presses the forward switch 13, the CPU 251 reads from the external memory 16 a video signal of an image positioned one forwards from the image being read at the present from the external memory 16, and displays it on the liquid crystal monitor 11. Moreover, if the user presses the backward switch 14, the CPU 251 reads from the external memory 16 a video signal of an image positioned one backwards from the image being read at the present from the external memory 16, and displays it on the liquid crystal monitor 11. If the user presses the erase switch 15, the CPU 251 erases from the external memory 16 the video signal data of the image being read at the present from the external memory 16.

As discussed above, the binocular telescope in the third embodiment incorporates the imaging function, the auto-focusing signal is generated from the output of the imaging device 60, and the auto-focusing of the imaging device 60 and of the binocular optical systems 50 is simultaneously attained. It is therefore feasible to provide the binocular telescope including the auto-focusing mechanism without adding separately the auto-focusing mechanism to the binocular telescope. Further, the binocular telescope in the second embodiment is structured such that the imaging incident light is introduced from the imaging lens 5 separate from the objective lens 2, and hence this structure neither causes a decrease in the quantity of the light entering the eyepiece lens 4 of the binocular optical system 50 nor requires a light path diverging mechanism for diverging the light paths of the binocular optical systems 50. Accordingly, an advantage is that the imaging function and the auto-focusing function are provided, and nevertheless the image observed through the binocular telescope does not decline.

Further, the binocular telescope in the third embodiment discussed above takes the structure in which one single movable lens holder 54 incorporates the imaging movable lens 5b of the imaging device 60 and the movable lenses 2b of the binocular optical systems 50. Hence, it is possible to get both of the imaging optical system 60 and the binocular optical systems 50 focalized at the same time by use of the single stepping motor 58. Moreover, there is obtained an effect that the one AF control circuit system for controlling the stepping motor 58 is enough, thereby simplifying the configurations of the drive mechanism and of the control circuit.

The binocular telescope in the third embodiment is not. however, limited to the structure using the one movable lens holder 54 described above. For example, the imaging movable lens 5b of the imaging device 60 and the movable lenses 2b of the binocular optical systems 50, may be incorporated into separate lens holders driven respectively by two stepping motors. The two stepping motors may be controlled by control signals transmitted from one AF control unit 33. In the case of taking this structure, an optical geometry of the imaging lens 5 of the imaging device 60 is different from that of the objective lenses 2 of the binocular optical systems 50. Even if the movement quantity, needed for focusing, of the imaging movable lens 5b is different from the movement quantity of each of the movable lenses 2b, the movable lenses 2b and 5b can be simultaneously moved to the in-focus positions by presetting a ratio between the numbers of revolutions of the two stepping motors in accordance with a ratio between the movement quantities.

Further, the third embodiment adopts the auto-focusing system in which the movable lens holder 54 is moved by the stepping motor 58, however, a focusing mechanism in a manual system may also be actualized. To be more specific, a configuration is that the stepping motor 58 is replaced by a rotation knob to be manually rotated. According to this configuration, the user rotates the rotation knob to move the movable lens holder 54 to an in-focus position desired by the user, and is able to observe and executes imaging in the in-focus state desired by the user. In this case, it is also feasible to configure the system without providing the AF control unit 33, the high frequency component extraction circuit 31 and the wave detection circuit 32, wherein the operation of adjusting to the focal position is conducted based on only a judgement of the user. Further, this configuration may also be available, wherein the AF control unit 33, the high frequency component extraction circuit 31 and the wave detection circuit 32 are provided while incorporating a function of displaying the present in-focus state on the liquid crystal monitor 11 or within a visual field of the eyepieces 4, thus assisting the user to adjust the focal position.

Moreover, the binocular telescope described in the third embodiment takes the configuration that the binocular telescope main unit 1 is separate from the sub unit 10 including the liquid crystal monitor etc. As a matter of course, however, the liquid crystal monitor 11, the digital encoder 262, the operation switches 12, 13, 14, 15 etc may be mounted in the main unit 1. In the case of adopting this sort of integral configuration, the liquid crystal monitor 11 may be used as an electronic viewfinder. Hence, the user can observe the object while getting the eyes off the eyepieces 4, which leads to an easy-to-observe condition for a long period of time.

As discussed in the embodiments given above, according to the present invention, the observation optical system for observing the image is different from the imaging optical system for imaging the image observed, so that the observed image can be recorded while observing it without any decrease in brightness of the image observed. Further, the observation optical system and the imaging optical system are respectively independent, and hence the binocular telescope having the imaging function with no necessity of switching the optical systems can be obtained with a much simpler configuration. The binocular telescope can be therefore produced at a high efficiency.

According to the present invention, the object can be observed through the binocular telescope, while the image can be imaged by the imaging device independently, and the object observed through the binocular telescope can be imaged substantially the same as real.

What is claimed is:

1. A binocular telescope with an imaging function, comprising:
binocular optical systems including a couple of observation optical systems having objective lenses and eyepieces; and
an imaging device including an imaging optical system, for actualizing a visual field of a field angle that is substantially equal to a real field of an image observed through said binocular optical systems, and a photoelectric converting unit for converting an image obtained by said imaging optical system into an electric signal,
wherein said observation optical system and said imaging optical system have their optical axes different from each other.

2. A binocular telescope with an imaging function according to claim 1, wherein said imaging device is disposed in a middle position between said couple of observation optical systems when viewing said binocular telescope in a direction of said objective lens.

3. A binocular telescope with an imaging function according to claim 1 or 2, wherein said imaging device has an image signal output unit for displaying an image signal,
said image signal output unit has a liquid crystal monitor, and
said liquid crystal monitor is disposed in the middle between said couple of observation optical systems, and its display screen is set facing to an observer at least in a state of its being used.

4. A binocular telescope with an imaging function according to claim 1, further comprising:
an operation member for adjusting a focus; and
a focus adjusting operation mechanism for transferring a quantity of the operation of said operation member to said objective lenses and moving said objective lenses in a direction of the optical axis.

5. A binocular telescope with an imaging function according to claim 1, further comprising an interpupillary distance adjusting mechanism, connected to each of said couple of observation optical systems, for adjusting a spacing therebetween,
wherein said interpupillary distance adjusting mechanism is constructed of a central support member, a couple of gear members, disposed spaced away from each other in symmetry and rotatably supported by said central support member, for supporting respectively said observation optical systems, and an even-number of gears, disposed between said gear members, for transferring rotations to between said gear members.

6. A binocular telescope with an imaging function, comprising:
a couple of right and left binocular optical systems including objective lenses and eyepieces;
an imaging device for converting the light introduced other than through said objective lenses into an electric signal and executing an imaging process; and
an in-focus state detection circuit for generating, from the electric signal, a signal indicating an in-focus state of an image imaged by said imaging device,
wherein said binocular optical systems and said imaging device respectively contain movable lenses movable for adjusting focuses, and
said movable lenses of said binocular optical systems and said movable lens of said imaging device are each constructed to move corresponding to an output said in-focus state detection circuit.

7. A binocular telescope with an imaging function according to claim 6, wherein said movable lenses of said binocular optical systems and said movable lens of said imaging device, are held at the same time by a holding member, and
said holding member is fitted with a drive unit for moving said holding member corresponding to the output of said in-focus state detection circuit.

8. A method of adjusting a focus of a binocular telescope with an imaging function, comprising:
a step of observing an object through a couple of right and left observation binocular optical systems;
a step of converting the light into an electric signal by an imaging device different from said binocular optical systems; and
a step of adjusting a focus of said imaging device on the basis of the electric signal.
